(19) United States
(12) Patent Application Publication
(10) Pub. No.: US 2016/0041999 A1
(43) Pub. Date: Feb. 11, 2016

(54) QUERY ANALYZER

(71) Applicants: Frederik Kemner, Hamburg (DE); Jan Peter Kretschmer, Hamburg (DE); Zoltan Szamonek, Zurich (CH)

(72) Inventors: Frederik Kemner, Hamburg (DE); Jan Peter Kretschmer, Hamburg (DE); Zoltan Szamonek, Zurich (CH)

(73) Assignee: GOOGLE INC., Mountain View, CA (US)

(21) Appl. No.: 13/555,676

(22) Filed: Jul. 23, 2012

Related U.S. Application Data
(60) Provisional application No. 61/510,993, filed on Jul. 22, 2011.

(51) Int. Cl. G06F 17/30; G06Q 30/02

(52) U.S. Cl. CPC G06F 17/3087; G06F 17/30312; G06F 17/30241; G06F 17/30598

(57) ABSTRACT

Methods, systems, and apparatus, including computer programs encoded on a computer storage medium, for analyzing queries. One of the methods includes obtaining a plurality of queries submitted from a plurality of different client devices; determining a source geographic location for each of the plurality of queries based on information associated with a client device from which the query was submitted; determining a destination geographic location for each of the plurality of queries based on the respective first text portion of the query; determining a vertical market category for each of the plurality of queries; receiving a request to analyze queries according to a first vertical market category and at least one of a source geographic location or a destination geographic location; using one or more indexes to identify queries responsive to the request; and presenting data describing the queries responsive to the request.

### CROSS-REFERENCE TO RELATED APPLICATIONS

This application claims the benefit under 35 U.S.C. §119(e) of the filing date of U.S. Patent Application No. 61/510,993, for Query Analyzer, which was filed on Jul. 22, 2011, and which is incorporated here by reference.

### BACKGROUND

This specification relates to digital information retrieval, and particularly to analyzing queries that specify geographic locations.

Internet search engines provide information about Internet accessible resources (e.g., web pages, images, sounds, text documents, multimedia content, and other content) that are responsive to a user's search query by returning a set of search results in response to the query. A search result includes, for example, a Uniform Resource Locator (URL) and a snippet of information for resources responsive to a query. The search results can be ranked (i.e., put in an order) according to scores assigned to the search results by a scoring function. The scoring function ranks the search results according to various signals, for example, where (and how often) query terms appear in the search results and how common the query terms are in the search results indexed by the search engine.

### SUMMARY

In general, one innovative aspect of the subject matter described in this specification can be embodied in methods that include the actions of obtaining a plurality of queries submitted from a plurality of different client devices, wherein each of the queries comprises a respective first text portion and a respective non-overlapping second text portion; determining a source geographic location for each of the plurality of queries based on information associated with a client device from which the query was submitted; determining a destination geographic location for each of the plurality of queries based on the respective first text portion of the query; determining a vertical market category for each of the plurality of queries based the respective second text portion of the query; creating one or more indexes to index the source geographic locations, the destination geographic locations, and the vertical market categories for the plurality of queries; receiving a request to analyze queries according to a first vertical market category and at least one of a source geographic location or a destination geographic location; using the one or more indexes to identify queries responsive to the request; and presenting data describing the queries responsive to the request.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example search system for identifying search results in response to search queries.

FIG. 2 illustrates an example query analysis system.

FIG. 3 is an example query analysis graphical user interface.

FIG. 4 is another example query analysis graphical user interface.

Like reference numbers and designations in the various drawings indicate like elements.

### DETAILED DESCRIPTION

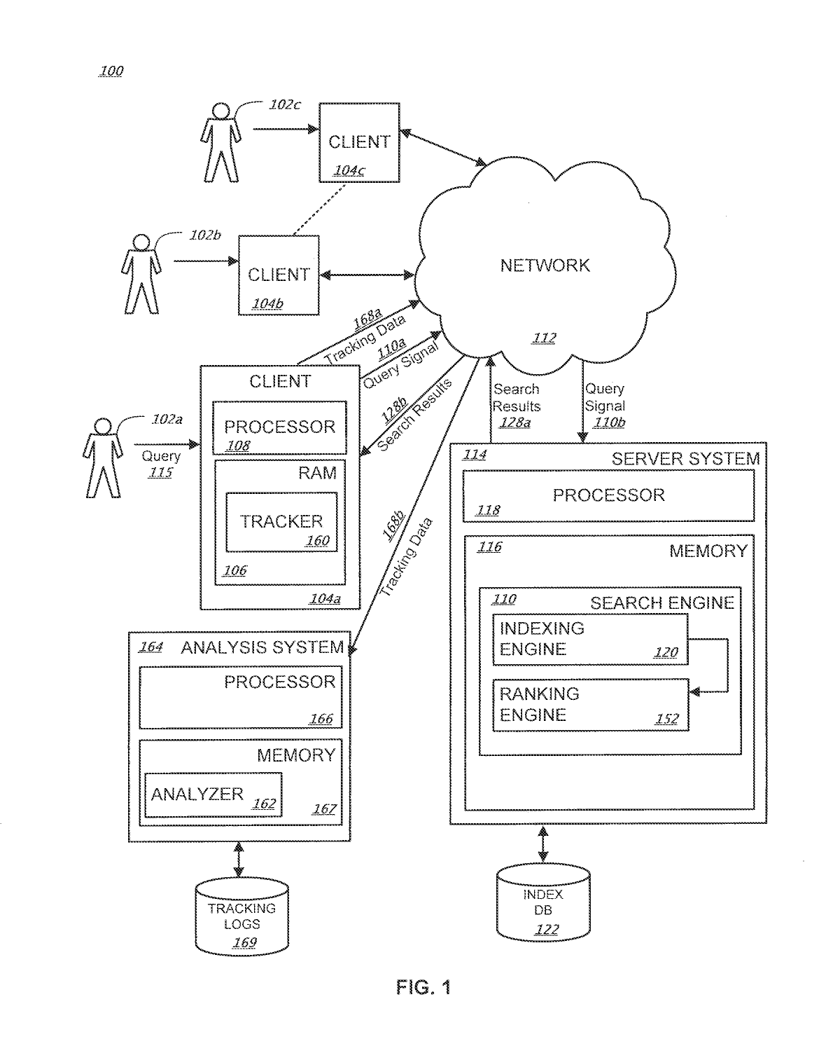

FIG. 1 illustrates an example search system 100 for identifying search results in response to search queries. Each search result can include summary information. The summary information can include a representative frame from the video, the video's title, a textual summary, the running time of the video, and/or a Uniform Resource Locator (URL) or other identifier specifying the location of the video.

The system 100 is an example of an information retrieval system in which the systems, components and techniques described herein can be implemented. Although several components are illustrated, there may be fewer or more components in the system 100. Moreover, the components can be distributed on one or more computing devices connected by one or more networks or other suitable communication media.

A user 102, e.g., users 102a, 102b, or 102c, interacts with the system 100 through a client device 104, e.g., client devices 104a, 104b, or 104c, or other device. For example, the client device 104 can be a computer terminal within a local area network (LAN) or wide area network (WAN). The client device 104 generally includes a random access memory (RAM) 106, or other memory and/or a storage device, and a processor 108. The processor 108 is structured to process instructions on the client device 104. The processor 108 is a microprocessor having one or more processor cores, for example. The processor 108 is structured to process instructions stored in the RAM 106, or other memory and/or a storage device included with the client device 104, to display graphical information for a user interface.

The RAM 106 on the client device 104 includes a tracker software program 160 for keeping track of user activity on the client device 104. The tracker 160 can send tracking data as a client-side signal 168a into the network 112, e.g., the Internet or other network. The data is forwarded to an analysis system 164 as a server-side signal 168b. The analysis system 164 generally includes a memory device 167, e.g., RAM or other memory and/or a storage device, and a processor 166. The processor 166 is structured to process instructions on the analysis system 164. The processor 166 is a microprocessor having one or more processor cores, for example. The memory device 167 includes an analyzer software program 162 for analyzing the tracking data.

The tracking data 168b can be stored in one or more tracking logs 169, which are used to record the collected information for multiple users. In various implementations, the recorded information includes log entries that indicate the IP (Internet Protocol) address or cookie of the client 104 that transmitted the information, the date and time the information was received, the type of data, and a value for the data. Examples of the types of data that are recorded in the tracking logs is presented in TABLE 1. Other types of tracking data are possible.

TABLE 1

| DATA TYPE | DATA VALUE |
|---|---|
| Query | Query text as submitted by a user through an input |
| | device such as a keyboard or converted from the |
| | user's speech. |
| Advertisement | Identification of an advertisement and a query |
| Impressions | where the advertisement was presented with the |
| | query's search results. |
| Advertisement | Identification of an advertisement and a query |
| Clicks | where the advertisement was presented with the |
| | query's search results and clicked on by a user. A |
| | click-through rate (CTR) can be determined for a |
| | given advertisement based on this information. |

A user 102a connects to the search engine 110 within a server system 114 to submit a query 115. When the user 102a submits the query 115 through an input device attached to a client device 104a, a client-side query signal 110a is sent into the network 112 and is forwarded to the server system 114 as a server-side query signal 110b. Server system 114 can be one or more server devices in one or more locations. A server device 114 includes a memory device 116, which can include the search engine 110 loaded therein. A processor 118 is structured to process instructions within the device 114. These instructions can implement one or more components of the search engine 110. The processor 118 can be a single or multi-threaded processor and can include multiple processing cores. The processor 118 can process instructions stored in the memory 116 related to the search engine 110 and can send information to respective client devices 104a-c, through the network 112, to create a graphical presentation in a user interface of the client device 104, e.g., a search results web page displayed in a web browser.

The server-side query signal 110b is received by the search engine 110. The search engine 110 uses the information within the user query 115, e.g. query terms, to find relevant resources. As used herein, resource is any data that can be provided by a website over a network and that is associated with a resource address. Resources include, for example, HTML pages, word processing documents, and portable document format (PDF) documents, images, videos, electronic games, and feed sources, to name just a few. The resources can include content, for example, words, phrases, images and sounds and may include embedded information, e.g., meta information and hyperlinks, and/or embedded instructions, e.g., scripted content.

The search engine 110 can include an indexing engine 120 that actively searches a corpus or collection of documents, e.g., web pages on the Internet, to index the resources found in that corpus, and the index information for the resources in the corpus can be stored in an index database 122. This index database 122 can be accessed to identify resources related to the user query 115. Note that, an electronic resource, which for brevity will simply be referred to as a resource, does not necessarily correspond to a file. A resource can be stored in a portion of a file that holds other resources, in a single file dedicated to the resource in question, or in multiple coordinated files. Moreover, a resource can be stored in a memory without having first been stored in file.

The search engine 110 includes a ranking engine 152 to rank the resources related to the user query 115 using a scoring or ranking function. The ranking of the resources can be performed using traditional techniques for determining an information retrieval (IR) score for indexed resources in view of a given query, for example. The relevance of a particular resource with respect to a particular search term or to other provided information may be determined by any appropriate technique.

To further improve such traditional resource ranking techniques, the ranking engine 152 determines an appropriate ranking for search results. Search results can be ranked according to traditional techniques for determining an information retrieval (IR) score for indexed resources that contain videos in view of a given query. The relevance of a particular resource with respect to a particular search term or other provided information may be determined by any appropriate scoring technique.

The search engine 110 forwards the final, ranked result list within a server-side search results signal 128a through the network 112. Exiting the network 112, a client-side search results signal 128b is received by the client device 104a where the results are stored within the RAM 106 and/or used by the processor 108 to display the results on an output device for the user 102a. The server system 114 may also maintain one or more user search histories based on the queries the server system 114 receives from a user, and from results that a user selected after a search was performed.

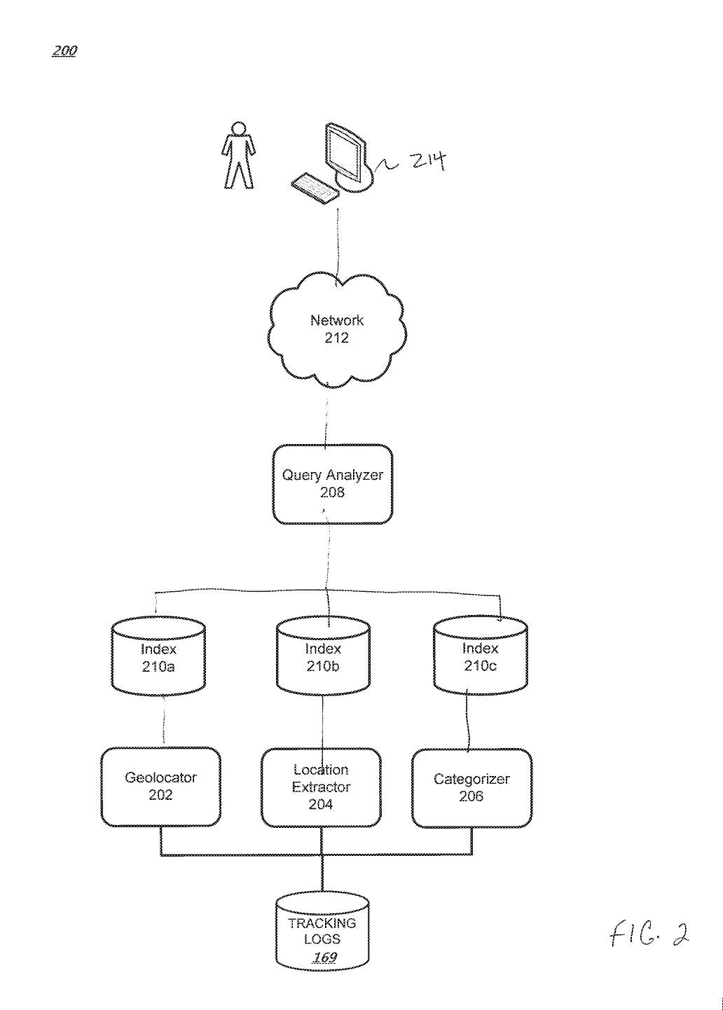

FIG. 2 illustrates an example query analysis system 200. The system 200 includes a geolocator 202, a location extractor 204, a query categorizer 206, and a query analyzer 208. The geolocator 202, location extractor 204, and categorizer 206 each have access to the tracking logs 169 and generate additional information to be associated with queries in the tracking logs. In some implementations, the geolocator 202, location extractor 204, and categorizer 206 can create one or more database indexes 210a-c that enable fast access to the additional information.

The geolocator associates a source geographic location, e.g., zip code, city, state, point of interest, and so on, with queries in the tracking logs 169 based on, for example, the Internet Protocol (IP) addresses of the client devices from which the queries were entered or by using cookie values stored on the client devices. For example, an IP address can be mapped to a geographic location using the predetermined location information for IP address blocks provided by Internet Service Providers (ISPs). Other ways of mapping an IP address are possible. Alternatively, a cookie value can be encoded with the identification of a user of the client device. The user identification can be used to look up a user's geographic location in user profile or account information. In some implementations, the source geographic location associated with a query by the geolocator 202 is provided at a granularity that protects the privacy of users. That is, the source geographic location is a geographic area that is large enough to prevent the identification of individual users. In some implementations, the geographic location can be include a hierarchy of locations such as country, state, city, and subdivision within the city. A database index 210a of source geographic location information associated with queries in the tracking logs 169 can created for use by the query analyzer 208, as described below.

The location extractor 204 associates a destination geographic location with queries in the tracking logs 169 based on respective text of the queries. The location extractor 204 first identifies any parts of the query, e.g., one or more letters, numbers, or combinations thereof, that may refer to a geographic location. For example, given the query “hotels paris” the portion of the query that refers to a geographic location is “paris”. The portion of the query that refers to a geographic location can come before or after another portion of the query. In some implementations, a table maps terms or keywords in a query to predetermined geographic locations. For example, the term “paris” could be mapped to Paris, France.

In further implementations, a probability is determined as to whether an IP address or cookie associated with the query should be mapped to a predetermined geographic location. For example, the term “paris” can be mapped to either “Paris, Texas” or “Paris, France”. Given that the source geographic location of the query is not in Paris, Tex., for example, the probability that the term “paris” refers to France would be higher. Other ways of determining a geographic location from query terms are possible. The determined geographic location is used as the destination geographic location. A database index 210b of destination geographic location information associated with queries in the tracking logs 169 can be created for use by the query analyzer 208, as described below.

The categorizer 206 associates a vertical market category with queries in the tracking logs 169 based on text of the query. A vertical market category describes a group of similar businesses and customers that engage in trade based on specific and specialized needs, such as restaurants and golf equipment manufacturers, for instance. A given category can be part of a hierarchy of categories such as travel→lodging and accommodations→restaurants. The categorizer 206 first identifies any parts of the query, e.g., one or more letters, numbers, or combinations thereof, that do not refer to a geographic location. For example, given the query “hotels paris” the portion of the query that does not refer to a geographic location is “hotels”. The portion of the query that does not refer to a geographic location can come before or after another portion of the query. In some implementations, a table that maps terms or keywords in a query to predetermined vertical market categories. For example, the term “hotel” could be mapped to “lodgings”. Other ways of determining a vertical market category from query terms are possible. A database index 210c of vertical market category information associated with queries in the tracking logs 169 can created for use by the query analyzer 208, as described below.

The query analyzer 208 analyzes query information according to the determined vertical market categories using one or more of the indexes 210a-c and tracking logs 169, and can provide the analysis for presentation in a graphical user interface of one or more client computing devices 214 that can communicate with the query analyzer 208 through a computer network 212. In some implementations, the query analyzer 208 determines, for a given time period and vertical market category, the number of queries, the text of the queries, the aggregate click-through rate of advertisements presented with search results for the queries, and/or the number of advertisement impressions for advertisements presented with search results for the queries. The determination can be restricted according to queries matching a specified source geographic location, destination geographic location, or both. Other analysis is possible.

The information generated by the query analyzer 208 can be used by advertisers to gain insight into how to target their advertising campaigns, for example, by associating advertisements with popular queries, or terms from the queries, that match the analysis criteria. In some implementations, the analyzer 208 presents queries matching the analysis criteria that occur in the tracking logs a number of times beyond a threshold number, e.g., 1000. The analyzer 208 can also access information to determine revenue generated from conversions, e.g., making an online purchase or submitting a form to request additional information in response to an advertisement. In some implementations, the analyzer 208 presents queries that have associated conversions beyond a threshold number of conversions.

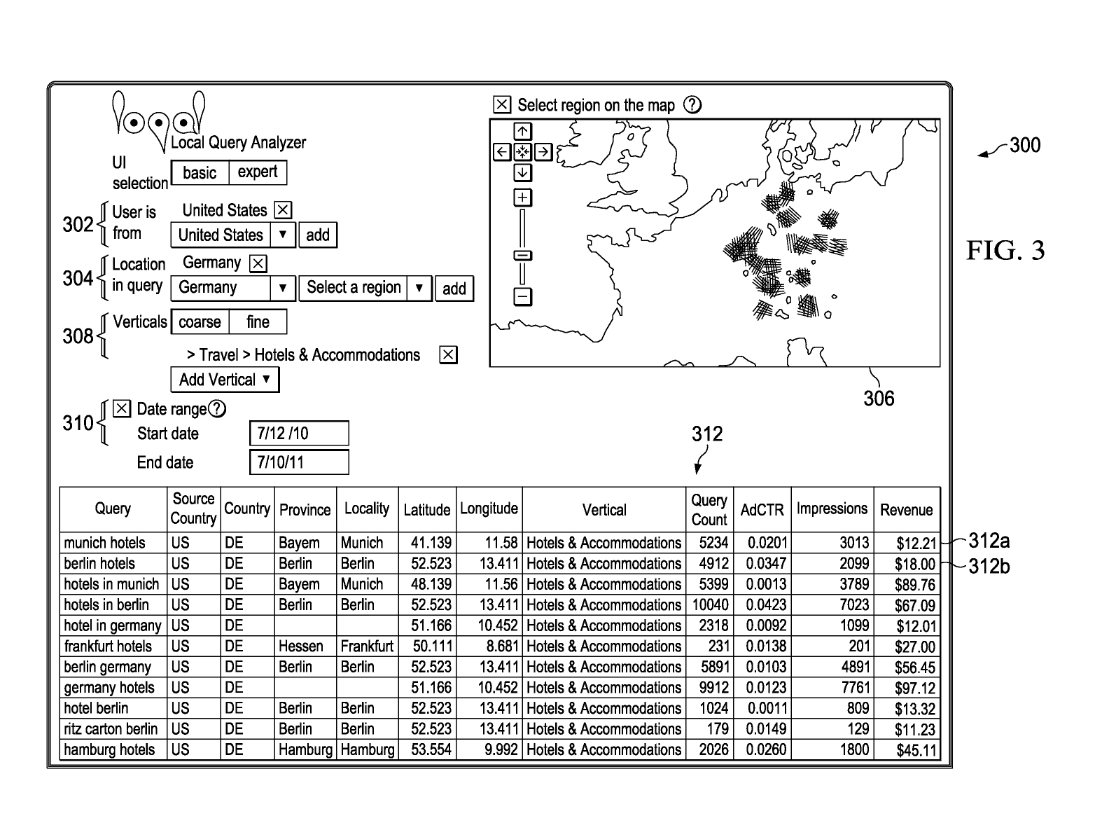

FIG. 3 is an example query analysis graphical user interface 300 as provided by query analyzer 208. User input area 302 allows specification of an optional source geographic location, e.g., United States. User input area 304 allows specification of a destination geographic location, e.g., Germany. User input area 308 allows the specification of one or more vertical market categories, e.g., >travel>hotels & accommodations. User input area 310 allows the specification of a time period for performing the analysis, e.g., Jul. 12, 2010 through Jul. 10, 2011. The user input areas are used by the query analyzer 208 to establish the analysis criteria. In some implementations, the destination geographic location can be specified by user interaction with the map 306 such as, for example, the user drawing a rectangle or other shape over a region of interest. The results of the analysis are presented in area 312 of the user interface and, optionally, indicated on the map 306 as colored regions. The results are presented in a table form. Each row of the table represents a unique query that matches the query criteria. By way of illustration, row 312a is for query “munich hotels” that is associated with the specified source and destination geographic locations. The results can present a count of the number of times the query occurred for the given criteria as well as other information such as impressions and click-through rates of advertisements for the query.

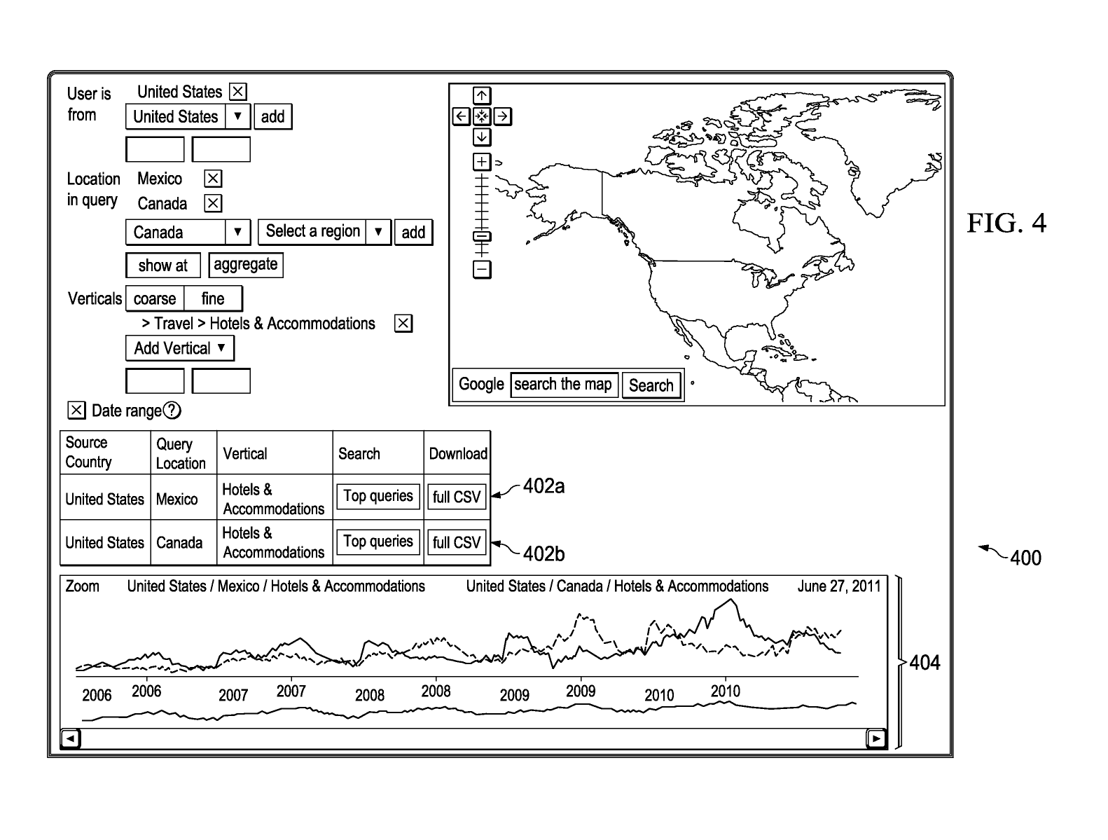

FIG. 4 is another example query analysis graphical user interface 400 as provided by query analyzer 208. The user interface 400 compares counts of queries over time in graph 404 for one or more locations and verticals. In particular, the graph 404 separately plots counts for queries having a source location of the United States, a destination location of Mexico, and a vertical “Hotels & Accommodations” and counts for queries having a source location of the United States, a destination location of Canada, and a vertical “Hotels & Accommodations.”

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for query keyword analysis, the method comprising:
obtaining a plurality of queries submitted from a plurality of different client devices, wherein each of the queries comprises a respective first text portion and a respective non-overlapping second text portion;
determining, by one or more processors, a source geographic location for each of the plurality of queries based on information associated with a client device from which the query was submitted;
determining, by the one or more processors, a destination geographic location for each of the plurality of queries based on the respective first text portion of the query;
determining, by the one or more processors, a vertical market category for each of the plurality of queries based on the respective second text portion of the query;
creating, by the one or more processors, three or more indexes to index the source geographic locations, the destination geographic locations, and the vertical market categories for the plurality of queries, the three or more indexes including:
a source geographic location index associating the determined source geographic location for each of the plurality of queries with the respective queries having the respective determined source geographic location;
a destination geographic location index associating the determined destination geographic location for each of the plurality of queries with the respective queries having the respective determined destination geographic location; and
a vertical market category index associating the determined vertical market category for each of the plurality of queries with the respective queries having the respective determined vertical market category;
receiving, by the one or more processors, a request to analyze queries according to a vertical market category, a source geographic location, and a destination geographic location different than the source geographic location, the request corresponding to user entries made via a user interface;
using, by the one or more processors, the three or more indexes to identify queries responsive to the request; and
presenting, by the one or more processors and via the user interface, data describing the queries responsive to the request.

2. The method of claim 1, wherein determining the source geographic location for each of the plurality of queries comprises determining the source geographic location based on at least one of Internet Protocol (IP) addresses of respective client devices from which the queries were submitted, cookie values stored on respective client devices from which the queries were submitted, or user profiles of users associated with the respective client devices from which the queries were submitted.

3. The method of claim 1, wherein determining the source geographic location for each of the plurality of queries comprises associating a hierarchy of geographic locations of varying granularity as the source geographic location for each of the queries.

4. The method of claim 1, wherein determining the destination geographic location for each of the plurality of queries comprises, for each query, identifying portions of the query that are mapped to geographic locations in a predetermined mapping of terms to geographic locations.

5. The method of claim 4, wherein identifying portions of the query that are mapped to geographic locations in a predetermined mapping comprises:
identifying a plurality of non-overlapping geographic locations based on terms mapped to multiple locations in the predetermined mapping; and
selecting among the plurality of non-overlapping geographic locations based on the source geographic location of the client device from which the query was submitted.

6. The method of claim 1, wherein determining the vertical market category for each of the plurality of queries comprises determining a hierarchy of vertical market categories for each of the plurality of queries.

7. The method of claim 1, wherein determining the vertical market category for each of the plurality of queries comprises identify terms in the second text portion in a predetermined mapping of terms to vertical market categories.

8. (canceled)

9. The method of claim 1, wherein using the three or more indexes to identify queries responsive to the request comprises identifying queries that both match the analysis criteria of the request and have more than a threshold number of occurrences in a tracking log.

10. The method of claim 1, wherein using the three or more indexes to identify queries responsive to the request comprises identifying queries that both match the analysis criteria of the request and exceed a conversion threshold.

11. The method of claim 1, wherein presenting data describing the queries responsive to the request comprises presenting, for each such query, at least one of the following: a number of submissions of the query, the text of the query, a click-through rate of advertisements presented with search results responsive to the query, a number of impressions for advertisements presented with search results responsive to the query, or an amount of revenue generated from conversion of advertisements presented with search results responsive to the query.

12. The method of claim 1, wherein presenting data describing the queries responsive to the request comprises presenting each of the following for each such query: a number of submissions of the query, the text of the query, a click-through rate of advertisements presented with search results responsive to the query, a number of impressions for advertisements presented with the search results responsive to the query, and an amount of revenue generated from conversion of advertisements presented with the search results responsive to the query.

13. The method of claim 1, wherein presenting data describing the queries responsive to the request comprises plotting at least one of the source geographic location or the destination geographic location of responsive queries on a map.

14. The method of claim 1, wherein presenting data describing the queries responsive to the request comprises plotting a time-line indicating the number of submissions of the queries as a function of times when the queries were submitted.

15. The method of claim 14, further comprising:
receiving second request to analyze queries according to the vertical market category and at least one of a second source geographic location or a second destination geographic location; and
using the three or more indexes to identify queries responsive to the second request; and
plotting the number of submissions of the queries responsive to the second request as a function of times when the queries responsive to the second request were submitted on the time-line.

16. A system query keyword analysis, the system comprising:
one or more processors;
a memory coupled to the one or more processors and storing instructions that when executed by the one or more processors cause the processors to perform steps comprising:
obtaining a plurality of queries submitted from a plurality of different client devices, wherein each of the queries comprises a respective first text portion and a respective non-overlapping second text portion;
determining a source geographic location for each of the plurality of queries based on information associated with a client device from which the query was submitted;
determining a destination geographic location for each of the plurality of queries based on the respective first text portion of the query;
determining a vertical market category for each of the plurality of queries based on the respective second text portion of the query;
creating three or more indexes to index the source geographic locations, the destination geographic locations, and the vertical market categories for the plurality of queries, the three or more indexes including:
a source geographic location index associating the determined source geographic location for each of the plurality of queries with the respective queries having the respective determined source geographic location;
a destination geographic location index associating the determined destination geographic location for each of the plurality of queries with the respective queries having the respective determined destination geographic location; and
a vertical market category index associating the determined vertical market category for each of the plurality of queries with the respective queries having the respective determined vertical market category;
receiving a request to analyze queries according to a first vertical market category, a source geographic location, and a destination geographic location different than the source geographic location, the request corresponding to user entries made via a user interface;
using the three or more indexes to identify queries responsive to the request; and
presenting, via the user interface, data describing the queries responsive to the request.

17. A tangible, non-transitory, machine-readable medium storing instructions that when executed by a computing system cause the computing system to perform steps comprising:
obtaining a plurality of queries submitted from a plurality of different client devices, wherein each of the queries comprises a respective first text portion and a respective non-overlapping second text portion;
determining a source geographic location for each of the plurality of queries based on information associated with a client device from which the query was submitted;
determining a destination geographic location for each of the plurality of queries based on the respective first text portion of the query;
determining a vertical market category for each of the plurality of queries based on the respective second text portion of the query;
creating three or more indexes to index the source geographic locations, the destination geographic locations, and the vertical market categories for the plurality of queries;
receiving a request to analyze queries according to a first vertical market category, a source geographic location, and a destination geographic location different than the source geographic location, the request corresponding to user entries made via a user interface;
using the three or more indexes to identify queries responsive to the request; and
presenting, via the user interface, data describing the queries responsive to the request.

18. The medium of claim 17, wherein the three or more indexes comprise:
a source geographic location database index associating the determined source geographic location for each of the plurality of queries with the respective queries having the respective determined source geographic location;
a destination geographic location database index associating the determined destination geographic location for each of the plurality of queries with the respective queries having the respective determined destination geographic location; and
a vertical market category index database associating the determined vertical market category for each of the plurality of queries with the respective queries having the respective determined vertical market category.

19. The system of claim 16, wherein the three or more indexes comprise:
a source geographic location index associating the determined source geographic location for each of the plurality of queries with the respective queries having the respective determined source geographic location;
a destination geographic location index associating the determined destination geographic location for each of the plurality of queries with the respective queries having the respective determined destination geographic location; and
a vertical market category index associating the determined vertical market category for each of the plurality of queries with the respective queries having the respective determined vertical market category.

20. The system of claim 19, wherein:
the source geographic location index is a database index indexing the plurality of queries according to source geographic locations from which the queries were received;
the destination geographic location index is a database index indexing the plurality of queries according to the determined destination geographic location of each respective query; and
the vertical market category index is a database index indexing the plurality of queries according to the determined vertical market category of each respective query.
